(19) United States
(12) Patent Application Publication
(10) Pub. No.: US 2020/0218262 A1
(43) Pub. Date: Jul. 9, 2020

(54) SELF-DRIVING LUGGAGE AND METHOD OF OPERATING THEREOF

(71) Applicant: LINGDONG TECHNOLOGY(BEIJING)CO.LTD, Beijing (CN)

(72) Inventors: YAXIN GUAN, Beijing (CN); WEI SONG, Beijing (CN); OU QI, Beijing (CN); Chiung-Lin CHEN, Beijing (CN)

(21) Appl. No.: 16/574,018

(22) Filed: Sep. 17, 2019

(30) Foreign Application Priority Data
Jan. 9, 2019 (CN) 201910019588.8

(51) Int. Cl. G05D 1/00; B60L 50/60; A45C 5/04; A45C 5/14; A45C 13/00; A45C 13/26; A45C 15/06

(52) U.S. Cl. CPC G05D 1/0088; B60L 50/60; A45C 5/04; A45C 15/06; A45C 13/001; A45C 13/262; A45C 5/14

(57) ABSTRACT

This invention relates to a self-driving luggage and a method of showing its operation. A self-driving luggage comprises a plurality of electronic components, covered and protected by protecting shells. Wherein the protecting shells are at least partly made of transparent materials and at least one of the case shells is made of transparent materials such that the operation of the electronic components is capable to be observed without opening the shells of the luggage. The said electronic components include a light indicator configured to alert or indicate a testing result.

### BACKGROUND OF THE INVENTION

### 1. Field of the Invention

Embodiments disclosed herein relate to a self-driving luggage with driving wheels, and in particular, to a method of showing the operation of the self-driving luggage.

### 2. Description of the Prior Art

As the technology develops, self-driving luggage becomes common to the public. While travelling, people used to pull a luggage which costs much energy. With the help of the self-driving luggage, people can free his/her hands and save energy. The self-driving luggage comprises a lot of electronic components, such as processors and sensors. To protect these electronic components, protecting shells are used to cover these components.

In general, the protecting shells are non-transparent. However, people cannot observe the operation of the electronic components and also cannot timely find the abnormality or tackle a problem when using the luggage. A light indicator is configured to indicate the abnormality or the problem when using the luggage. If the light indicator is disposed inside a luggage by drilling a hole on a case shell, the rigidity of the luggage will be reduced. If the light indicator is disposed outside the luggage, it would be easy for the light indicator to be collided or it would be difficult to connect the light indicator with the electronic components.

Accordingly, a need exists for an improved self-driving luggage. People can observe the electronic components and the operation of them without opening the luggage.

### SUMMARY OF THE INVENTION

Embodiments of this invention relate in general to a self-driving luggage with a plurality of driving wheels and a plurality of electronic components. A method of observing the operation of electronic components without opening protecting shells and/or case shells is also disclosed.

The electronic component may include a light indicator to indicate the operation of the electronic component.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

These and other features of the invention will now be described with reference to the drawings summarized below. These drawings (not to scale) and the associated descriptions are provided to illustrate preferred embodiments of the invention and are not intended to limit the scope of the invention. Like designations denote like elements.

FIG. 1 schematically illustrates a self-driving luggage in accordance with one embodiment of the invention.

FIG. 2 schematically illustrates a driving wheel and a slip ring in accordance with one embodiment of the invention.

FIG. 3 schematically illustrates a handle grip and a pull rod in accordance with one embodiment of the invention.

FIG. 4A and FIG. 4B show how a light indicator indicates the status of the luggage.

FIG. 5A and FIG. 5B show how a light indicator indicates the status of the luggage.

### DETAILED DESCRIPTION

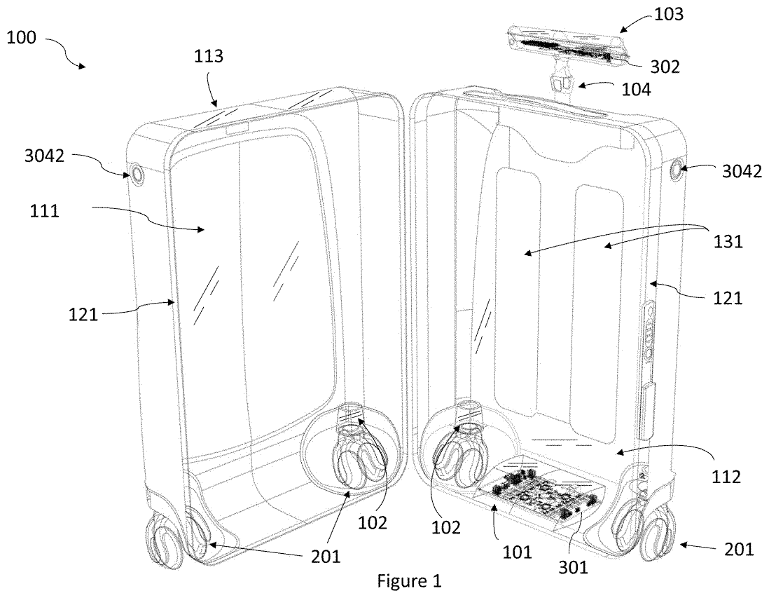

A self-driving luggage 100 shown in FIG. 1 comprises a body and a plurality of driving wheels 201. The body includes protecting shells 101-104 and case shells 111-113. The protecting shells 101-104 are configured to protect electronic components. The electronic components are coupled to a battery. The protecting shell 101 covers and protects a power distributor 301. The protecting shell 102 covers and protects a slip ring. The protecting shell 103 covers and protects a sensor connection plate 302. The protecting shells 101˜104 and the case shells 111˜113 are at least partly made of transparent materials so that the operation of the electronic components can be observed through them without the need to open any shells. To be more specifically illustrated, a user can observe the operation of the power distribution board 301 through the case shell 111 and the protecting shell 101 without opening the luggage 100. The user can also observe the operation of the slip ring and driving wheel 201 through the case shell 111 and the protecting shell 102 without opening the luggage 100. The user can further observe the operation of the power distribution board 301 through the case shell 112 and the protecting shell 101 without opening the luggage 100. The user can observe the operation of the slip ring and driving wheel 201 through the case shell 112 and the protecting shell 102 without opening the luggage 100. The user can observe the operation of the power distribution board 301 through the case shell 113 and the protecting shell 101 without opening the luggage 100. The user can observe the operation of the slip ring and the driving wheel 201 through the case shell 113 and the protecting shell 102 without opening the luggage 100.

The protecting shells 101˜104 and the case shells 111˜113 can be made of polyethylene, LDPE (low density polyethylene), polypropylene, PVC, polystyrene, acrylonitrile-styrene copolymer, PET, polycarbonate, transparent ABS (Acrylonitrile butadiene styrene) or copolymer of the foresaid compounds.

The rigidity of the self-driving luggage 100 is reduced as the transparent case shells 111˜113 are lack of rigidity. Therefore metal frame structures 121 (e.g. alumina frame) are arranged at the edges of the case shells to enhance the rigidity of the self-driving luggage 100. In one embodiment, the self-driving luggage 100 includes a transparent case shell 111, a transparent case shell 112 and a transparent shell 113. The frame structure 121 is non-transparent.

In one embodiment, the self-driving luggage 100 includes one or more non-transparent soft containers 131. The non-transparent soft containers 131 are configured to collect battery and other personal items and are disposed inside or outside of the case shell. The non-transparent soft containers 131 are capable to protect the user's privacy better.

A power distribution board 301 is configured to control and deliver a power from battery to the driving wheels 201. In one embodiment, the power distribution board 301 includes a microprocessor and a light indicator. The microprocessor is configured to adjust electronic current provided to the driving wheels 201. The light indicator is configured to indicate the operation of the power distribution board 301, including whether the battery operates normal, whether the electronic current supply is normal and the remaining power of battery. In one embodiment, the operation of the power distribution board 301 includes the information returned by the driving wheels 201, such as the current orientation of the driving wheels and the speed of the driving wheels. The information can be read through the light indicator. In one embodiment, the light indicator will warn the user if the deviation between the speed returned by the driving wheels 201 and the default speed under the same current falls above a threshold. In one embodiment, the light indicator will warn the user if the deviation between the current speed and the expected speed, and/or the deviation between current orientation and the expected orientation of the driving wheels 201 falls above a threshold under the default voltage and the default electronic current.

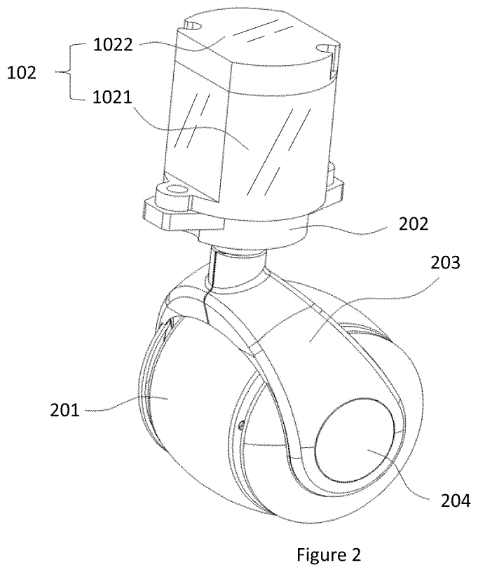

As shown in FIG. 2, the protecting shell 102 covering the slip ring comprises an upper shell 1022 and a bottom shell 1021. The upper shell 1022 and the bottom shell 1021 are at least partly made of transparent materials. Hence, the user can observe the operation of the slip ring through the protecting shells 102 without opening it. The connecting elements 202-204 are configured to connect the slip rings and driving wheels 201.

In another embodiment, the protecting shell 102 protects a liftable wheel module. The liftable wheel module comprises a linkage motivated by a motor and configured to lift up or put down the wheels 201. The user can observe the operation of the liftable wheel module through the protecting shell 102 without opening it.

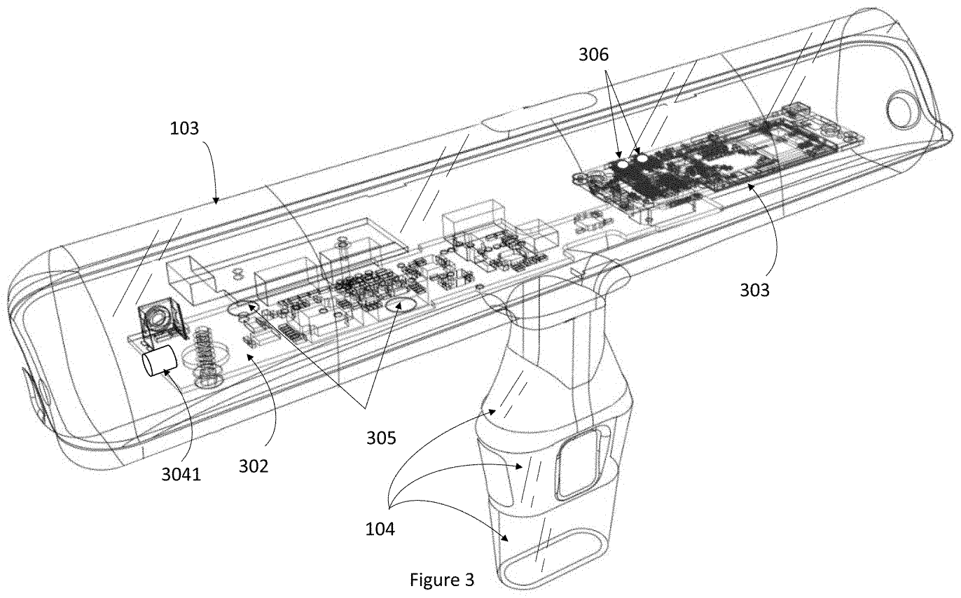

As depicted in FIG. 3, the protecting shell 103 comprises the handle grip and the protecting shell 104 comprises the pull rod of the self-driving luggage. The sensor board 302, a wireless communication module 303 and a sensor 3041 are disposed inside the handle grip. The protecting shell 103 is at least partly made of transparent materials such that the user can observe the operation of the sensor board 302, the wireless communication module 303 and the sensor 3041 through the protecting shell 103 without opening it. The height of the handle grip is capable to be adjusted to the user's height or preference in order to make sure the quality of the communication and sensing of the sensor.

In one embodiment, the sensor board 302 comprises a microprocessor and alight indicator 305. Wherein the microprocessor is configured to receive the information returned by the sensor 3041 and the light indicator 305 is configured to indicate the operation of the sensor board 302. The operation of the sensor board 302 includes whether the sensor 3041 operates normal, whether the distance between the user and the luggage is within default threshold. The sensor 3041 is configured to take video or sense the distance. For example, the sensor 3041 is a camera or a proximity sensor. The proximity sensor is an ultrasonic proximity sensor or a laser based proximity sensor. In one embodiment, the microprocessor will compare the current distance between the user and the luggage returned by the sensor with the default distance range. If the current distance does not fall within the default distance range, the light indicator 305 will warn the user. In one embodiment, the luggage 100 is configured to follow the user based on the information received from the sensor, the light indicator 305 is configured to indicate the luggage is in a side follow mode or in a rear follow mode, wherein under the side following mode the luggage 100 follows along a side of the user, and under the rear following mode the luggage 100 follows along behind the user. In one embodiment, the luggage 100 is configured to avoid the obstacle based on the information received from the sensor; the light indicator 305 is configured to indicate whether an autonomous obstacle avoidance mode is on. In one embodiment, the light indicator 305 is configured to tell whether the luggage is currently avoiding obstacle. In one embodiment, the light indicator 305 is used to tell which mode is on, a self-driving mode or a manual pulling mode. Under the self-driving mode, the luggage 100 will follow the user autonomously within a certain distance by the driving wheels; under the manual pulling mode, the user will pull the pull rod to move the luggage 100 and the driving wheels will not drive by itself.

In one embodiment, the wireless communication module 303 includes a microprocessor and a light indicator 306. Wherein the microprocessor is configured to communicate wirelessly to the user's mobile phone; the light indicator 306 is configured to indicate the operation of the wireless communication module 303. The operation of the module 303 includes whether the connection between the user's mobile phone and the module 303 is successful and whether the information is being transmitted. In one embodiment, the microprocessor will compare the firmware version of the luggage with the latest version obtained from a remote server and detected by mobile phone application. If the firmware of the luggage is not the latest version, the light indicator 306 will alert the user and the mobile phone application will suggest the user to update the firmware of the luggage.

In one embodiment, the light indicator 305 or 306 is used to show which mode is on, the photo-taking mode or the video-taking mode. In this embodiment, the sensor 3041 or the sensor 3042 is a camera configured to take a photo or a video. A frequency of light indicator blinking indicates which mode is on, the picture mode or the video mode, different blinking rate for example. The frequency of blinking also indicates a countdown to take a picture or a video. The wireless communication module 303 will transmit the photos or videos to user's mobile phone. During this transmitting process, the light indicator 306 is in the first mode. If the transmitting is failed, the light indicator 306 will be in second mode. For example, the first mode and the second mode are distinguished by the light color or the blinking frequency.

In one embodiment, the protecting shell 104 is the pull rod of the luggage. The proximity sensor and the indicator light (not shown in the figure) are disposed within the pull rod. The protecting shell 104 is at least partly made of transparent materials. Therefore, the user can observe the operation of the proximity sensor and the light indicator through the protecting shell 104 without opening it. The height of the proximity sensor is capable to be adjusted to the user's height or preference in order to make sure the sensing of the sensor. The height of the light indicator is capable to be adjusted to the user's height or preference in order to make sure the light indicator is in a position easier to be observed by the user.

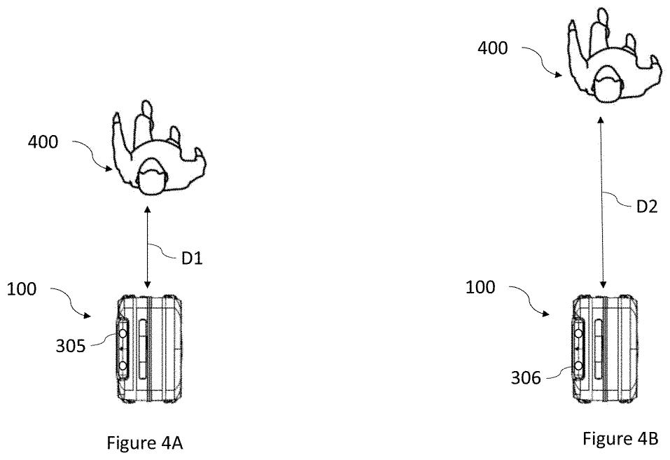

As shown in FIGS. 4A & 4B, the light indicator 305 and/or 306 indicates current status of luggage 100 while the self-driving luggage 100 is in a rear follow mode. For example, when a rear distance D1 between the self-driving luggage 100 and a user 400 falls below a threshold, the light indicator 305 will be in a first display mode, remain on for example. When a distance D2 between the self-driving luggage 100 and the user 400 falls above the threshold, the light indicator 306 will be in a second display mode, keep blinking for example. The luggage 100 detects the distance between the luggage 100 and the user 400 via the sensor 3041 or the sensor 3042. When the luggage 100 fails to detect the user 400 or to locate the user 400's position, the light indicator 305 or 306 will alert in a way different from the foresaid such as a different blinking frequency or a different light color. In another embodiment, the same light will use different display modes, different blinking frequency or light colors for example, to indicate the luggage is current stop travelling or keep following.

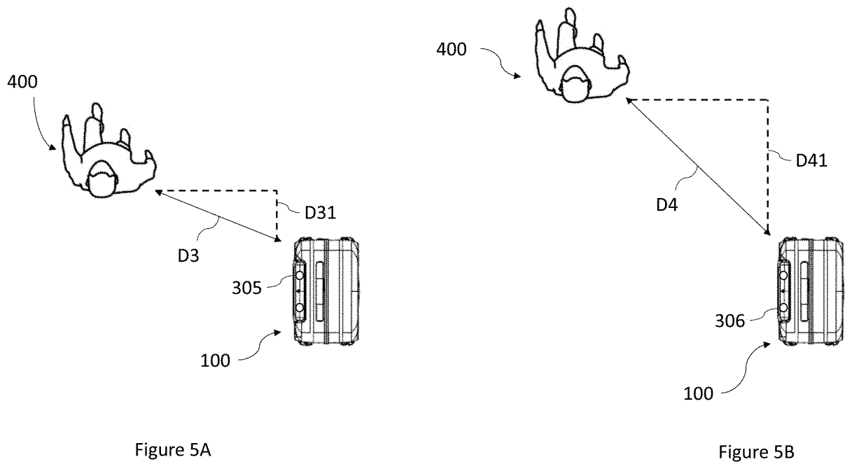

As shown in FIGS. 5A & 5B, the light indicator 305 and/or 306 indicates current status of luggage 100 while the self-driving luggage 100 is in a side follow mode. For example, when a distance D3 between the self-driving luggage 100 and the user 400 or D3's vertical component D31 falls below a threshold, the light indicator 305 will be in a first display mode, remain on for example, and the luggage 100 will stop travelling. When a distance D4 between the self-driving luggage 100 and the user 400 or D4's vertical component D41 falls above a threshold, the light indicator 306 will be in a second display mode, keep blinking for example, and the driving wheels 201 will move the luggage 100 towards the user 400. The luggage 100 detects the distance between the luggage 100 and the user 400 via the sensor 3041 or the sensor 3042. When the luggage 100 fails to detect the user 400 or to locate the user 400's position, the light indicator 305 or 306 will alert in a way different from the foresaid such as a different blinking frequency or a different light color. In another embodiment, the same light indicator will use different display modes, different blinking frequency or light colors for example, to indicate the luggage is current stop travelling or keep following.

In one embodiment, the light indicator 305 and/or 306 indicates whether the electronic component is on or not. In one embodiment, the light indicator 305 and/or 306 indicates whether the driving wheels 201 is been locked. The driving wheels 201 are capable to do a 360 degree rotation. However, if the driving wheels 201 are locked, the driving wheels 201 can only move in a particular direction.

In one embodiment, the self-driving luggage 100 includes a testing mode. Under the testing mode, the user can observe the status of the electronic components without opening the protecting shell. For example, the self-driving luggage 100 includes a driving wheel testing mode to confirm whether the speed and direction of the wheels are equal to default ones. Under this mode, the driving wheels are motivated by a certain electronic current. If the testing results are different from the default ones, the light indicator 305 and/or 306 will alert. In another example, the self-driving luggage 100 includes a UWB locating module. If the UWB locating module fails to communicate with a UWB device of the user (a wristband for example), the light indicator 305 and/or 306 will alert. In another example, the self-driving luggage 100 includes a proximity sensor testing mode. Under this mode, light indicator 305 and/or 306 will indicate the real-time distance of the distance between the user and the luggage.

In one embodiment, the wireless connection end device (for example, the user's mobile phone) will suggest to operate the testing mode when the self-driving luggage 100 detects an abnormality. For example, the self-driving luggage 100 includes a UWB locating module. When the UWB locating module fails to connect with the personal UWB device (a wristband as an example) for a long time, a suggestion to operate the testing mode will show on the mobile phone.

The light indicator mentioned above may be one or more LED lights, screens or other electronic components through which the user can observe the status change.

While the foregoing is directed to embodiments of the disclosure, other and further embodiments of the disclosure thus may be devised without departing from the basic scope thereof, and the scope thereof is determined by the claims that follow.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A self-driving luggage, comprising:
a body;
a plurality of driving wheels;
a plurality of electronic components, coupled to a battery; and
a protecting shell, configured to cover and protect the electronic component,
wherein the protecting shell is at least partly made of transparent materials such that the operation of the electronic component is capable to be observed through the protecting shell.

2. The self-driving luggage of claim 1, wherein the electronic components include a power distribution board configured to provide power to the driving wheels,
wherein the power distribution board includes a microprocessor configured to adjust electronic current provided to the driving wheels, and a light indicator configured to indicate the operation of the power distributor;
wherein the light indicator is capable to be observed through the protecting shell.

3. The self-driving luggage of claim 2, wherein the light indicator is configured to warn if a first deviation or a second deviation falls above a threshold under a default voltage and a default electronic current, wherein the first deviation is between a current speed and an expected speed of the driving wheels, wherein the second deviation is between current orientation and the expected orientation of the driving wheels.

4. The self-driving luggage of claim 1, wherein the electronic components include a slip ring coupled to the driving wheel and configured to rotatably cover a plurality of power lines, wherein the power lines are configured to provide the power to the driving wheel;
wherein the slip ring is capable to be observed through the protecting shell.

5. The self-driving luggage of claim 1, wherein the electronic components include a liftable wheel module;
wherein the liftable wheel module includes a linkage and the driving wheels;
wherein the linkage is configured to lift up or put down the driving wheels;
wherein the liftable wheel module is capable to be observed through the protecting shell.

6. The self-driving luggage of claim 1, wherein at least one case shell of the self-driving luggage is made of transparent materials such that the operation of the electronic components is capable to be observed through the protecting shell and the case shell.

7. The self-driving luggage of claim 1, wherein the electronic component is capable to run a testing mode where the status of the electronic component tested is capable to be observed through the protecting shell.

8. The self-driving luggage of claim 6, comprising a wireless connected mobile device wherein the device is configured to suggest the user to operate the testing mode when the luggage detects an abnormality.

9. The self-driving luggage of claim 1, wherein the electronic components include a sensor board, the protecting shell includes a handle grip;
wherein the sensor board is disposed within the handle grip and connects a camera or a proximity sensor;
wherein the handle grip is at least partly made of transparent materials;
wherein the sensor board is capable to be observed through the handle grip.

10. The self-driving luggage of claim 1, wherein the protecting shell includes a handle grip and further comprises:
a sensor configured to measure a distance between a user and the luggage; and
a light indicator disposed within the handle grip;
wherein the light indicator is configured to indicate whether the distance is within a default threshold;
wherein the handle grip is at least partly made of transparent materials;
wherein the light indicator is capable to be observed through the handle grip.

11. The self-driving luggage of claim 1, wherein the protecting shell includes a handle grip and further comprises:
a sensor configured to detect a user moving;
a processing unit configured to follow the user based on the information received from the sensor; and
a light indicator disposed within the handle grip and configured to indicate the luggage is in a side follow mode or in a rear follow mode, wherein under the side following mode the luggage follows along a side of the user, and under the rear following mode the luggage follows along behind the user;
wherein the handle grip is at least partly made of transparent materials;
wherein the light indicator is capable to be observed through the handle grip.

12. The self-driving luggage of claim 1, wherein the protecting shell includes a handle grip and further comprises:
a sensor configured to detect an obstacle;
a processing unit configured to avoid the obstacle based on the information received from the sensor; and
a light indicator disposed within the handle grip and configured to indicate whether an autonomous obstacle avoidance mode is on;
wherein the handle grip is at least partly made of transparent materials;
wherein the light indicator is capable to be observed through the handle grip.

13. The self-driving luggage of claim 1, wherein the protecting shell includes a handle grip and further comprises:
a sensor configured to detect a user moving;
a processing unit configured to follow the user based on the information received from the sensor; and
a light indicator disposed within the handle grip and configured to indicate which mode is on, a self-driving mode or a manual pulling mode;
wherein the handle grip is at least partly made of transparent materials;
wherein the light indicator is capable to be observed through the handle grip.

14. The self-driving luggage of claim 1, wherein the protecting shell includes a handle grip and further comprises:
a wireless communication module disposed within the handle grip and configured to communicate wirelessly to a mobile device;
wherein the handle grip is at least partly made of transparent materials;
wherein the wireless communication module is capable to be observed through the handle grip.

15. The self-driving luggage of claim 13, further comprising a light indicator disposed within the handle grip;
wherein the light indicator is configured to indicate whether a connection is successfully established to the mobile device;
wherein the light indicator is capable to be observed through the handle grip.

16. The self-driving luggage of claim 14, wherein the light indicator is configured to further indicate whether information is currently being transmitted and capable to be observed through the handle grip.

17. The self-driving luggage of claim 13, further comprising a light indicator disposed within the handle grip;
wherein the light indicator is configured to indicate whether the firmware version of the luggage is a latest version comparing to a version number obtained from a remote server through the mobile device;
wherein the light indicator is capable to be observed through the handle grip.

18. The self-driving luggage of claim 1, wherein the electronic components include a proximity sensor; the protecting shell includes a pull rod;
wherein the proximity sensor is disposed within the pull rod that includes a light indicator indicating the operation of the proximity sensor;
wherein the pull rod is at least partly made of transparent materials;
wherein the light indicator is capable to be observed through the pull rod.

19. The self-driving luggage of claim 1, wherein the protecting shell includes a handle grip and further comprises:
a camera configured to take a photo or a video; and
a light indicator disposed within the handle grip;
wherein the light indicator is configured to indicate whether the camera is under a photo-taking mode or a video-taking mode by different blinking rates;
wherein the handle grip is at least partly made of transparent materials;
wherein the light indicator is capable to be observed through the handle grip.

20. The self-driving luggage of claim 1, wherein the protecting shell includes a handle grip and further comprises:
a light indicator disposed within the handle grip;
wherein the light indicator is configured to indicate whether the driving wheels are been locked;
wherein the handle grip is at least partly made of transparent materials;
wherein the light indicator is capable to be observed through the handle grip.
